(19) United States
(12) Patent Application Publication
(10) Pub. No.: US 2024/0085008 A1
(43) Pub. Date: Mar. 14, 2024

(54) LUMINAIRE CONTROLLER FOR OUTDOOR LUMINAIRES

(71) Applicant: SIGNIFY HOLDING B.V., EINDHOVEN (NL)

(72) Inventor: Zhipei WANG, SHANGHAI (CN)

(21) Appl. No.: 18/273,798

(22) PCT Filed: Jan. 13, 2022
(86) PCT No.: PCT/EP2022/050646

§ 371 Date: Jul. 24, 2023

(30) Foreign Application Priority Data
Jan. 28, 2021 (WO) PCT/CN2021/074216
Feb. 25, 2021 (EP) 21159344.7

(51) Int. Cl. F21V 23/00; F21S 8/08; F21V 23/04

(52) U.S. Cl. CPC F21V 23/007; F21S 8/086; F21V 23/002; F21V 23/0435; F21V 23/0464; F21W 2131/103

(57) ABSTRACT

An outdoor luminaire controller for mounting on an external face of an outdoor luminaire, comprising: a housing (10) having (14) mounted at the base (12) for passing a cable (16) from the interior volume of the housing (10) through the base (12) to the outside of the housing beneath the base, and for connecting the luminaire controller to the external face, wherein the cable routing unit (14) has an adjustable configuration relative to the base (12) of the housing thereby to adjust the location from which the cable extends down from the base (12).

### FIELD OF THE INVENTION

The invention relates to a luminaire controller for outdoor luminaires, such as street lights, and in particular in which the luminaire controller is for mounting on an external face of the luminaire main housing.

### BACKGROUND OF THE INVENTION

It is known to mount an outdoor luminaire controller on an external face of an outdoor luminaire. The luminaire controller for example functions as a cellular communications unit for communicating with a lighting management system, and it may also include a light sensor for enabling automated lighting control, and a switching arrangement for controlling the switching of a mains supply to the luminaire.

A wired connection is needed between the luminaire controller and the inside of the main housing of the luminaire, where the lighting driver and light source (such as an LED arrangement) are located. A cable entrance hole is provided in an external wall of the luminaire housing, through which a cable can pass. This hole can also be used as the part of the mechanical connection between the luminaire main housing and the luminaire controller.

In a known design, the luminaire controller has a hollow threaded shaft extending down from its center. The luminaire controller is attached to the luminaire housing using this threaded shaft in combination with a fixing nut, and the cable passes through the central bore of the threaded shaft. The threaded shaft thus functions as a collar around the cable for routing the cable as well as providing a mechanical fixing.

It is desirable to fit the luminaire controller centrally on the luminaire housing, for example centrally on a top face. In this way, in the case of a street light, it cannot be seen from below. This is possible if the cable entrance hole is located centrally on the top face.

However, the ideal placement of the cable entrance hole in the exterior wall of the luminaire housing depends on the internal component layout of the luminaire. In some compact designs, the cable entrance hole has to be put at a side or corner of an external wall of the luminaire, for example to be placed away from the driver, and other internal components such as cables. Thus, with different designs and with increasing miniaturization, the cable entrance hole has different positions on an external wall of the luminaire housing.

A standard luminaire controller, with a centrally located cable exit, may then overlap an edge of the luminaire housing, particularly if the luminaire controller is large because it houses additional components for additional functionality. This overlap is undesirable as it may result in water ingress, reduced impact resistance and an undesirable appearance, for example with the overlap of the luminaire controller visible from below (in the case of a street light).

To avoid these issues, different luminaire controller designs are needed to match the different luminaire designs. It would instead be desirable to have a luminaire controller design which can be used with a greater variety of different luminaire designs, while addressing the issues outlined above.

### SUMMARY OF THE INVENTION

The invention is defined by the claims.

According to examples in accordance with an aspect of the invention, there is provided an outdoor luminaire controller for mounting on an external face of an outdoor luminaire, comprising:
a housing having an interior volume closed by a base; and
a cable routing unit mounted at the base for passing a cable from the interior volume of the housing through the base to the outside of the housing beneath the base, and for connecting the luminaire controller to the external face,
wherein the cable routing unit has an adjustable configuration relative to the base of the housing thereby to adjust the location from which the cable extends down from the base.

This luminaire controller has a cable routing unit which has an adjustable configuration so that the location, at which a cable (for power and control connections) extends down from the base, can be adjusted. The cable is to pass through a cable entrance hole in the external face to connect electrically the luminaire controller and the internal electrical components of the outdoor luminaire. The cable routing unit for example has a threaded shaft and a nut for clamping to the external face, at the location of the cable entrance hole, thereby also to mechanically connect the luminaire controller to the external face of the luminaire.

The adjustment of the cable routing unit enables the luminaire controller to be configured to fit to an external face with the hole in a variety of different positions, for example at different distances from an edge. In this way, it can be ensured that the luminaire controller does not overlap an edge of the external face. Thus, the luminaire can maintain a desired aesthetic appearance, for example with the controller mounted on an upper surface of the luminaire and not visible from below.

The cable routing unit for example comprises:
a rotary arm rotatably mounted to the base; and
a collar mounted on the rotary arm and extending downwardly from the rotary arm,
wherein the rotary arm is rotatable to enable the collar to be positioned at a range of positions along an arc beneath the base of the housing.

The position of the collar defines the position at which the cable enters the luminaire, as it passed through a central bore of the collar. The collar for example includes a cable gripping element. It has a central bore through which the cable can pass. The outside of the collar is for example threaded so that it is also used to make the mechanical connection to the luminaire housing using a nut.

A locking arrangement is preferably provided for locking the rotary arm in a selected position along the arc. This prevents the luminaire controller moving once installed.

The locking arrangement is for example for locking the rotary arm in a selected position along a continuous range of possible positions along the arc.

Alternatively, the locking arrangement is for locking the rotary arm in a selected one of a discrete set of positions along the arc.

In each case, the locking arrangement may simply comprise a screw to hold the rotary arm in a selected position.

The rotary arm for example has a first end pivotably coupled to the base and a second end at which the collar is mounted. Thus, the collar is mounted at the free end of the arm where the range of movement is greatest.

The rotary arm may comprise a cable passageway internally within the rotary arm extending between the first and second ends, wherein the cable passageway couples to the interior volume of the luminaire controller at the first end and couples to the collar at the second end. The cable is thus protected in its passage between the base of the luminaire controller and the main housing of the luminaire.

The first end is for example pivotably coupled to a peripheral location of the base. This enables the arm to be as long as possible, and hence with the greatest range of adjustment at its end.

The collar for example has a rotation prevention slot to prevent rotation of the outdoor luminaire controller when mounted to a luminaire. The slot for example engages with a tab formed in the luminaire housing.

The housing is for example circular, and the cable routing unit has one possible configuration in which the cable extends down from the center of the base. This corresponds to a conventional design, so that the luminaire controller may be used in the place of conventional designs.

The luminaire controller for example comprises, in the housing, a cellular communication system for communicating with a lighting management system. It may also comprise a light sensor, and a switching arrangement for controlling the switching of a mains supply to the luminaire.

The invention also provides an outdoor luminaire comprising:
a luminaire main housing;
a light source and a lighting driver mounted in the luminaire main housing; and
the luminaire controller as defined above mounted on an external face of the luminaire main housing.

The external face preferably has a hole, and the cable routing unit mechanically connects the luminaire controller to the external face at the location of the hole, with a cable passing through the hole between the luminaire main housing and the housing of the luminaire controller.

The luminaire controller is for example mounted on an upper external surface of the luminaire housing. The luminaire for example comprises a street light.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows one example of a known street light luminaire;

FIG. 2 shows the known connection between the luminaire controller and the main housing;

FIG. 3 shows the known luminaire controller separate from the luminaire housing;

FIG. 4 shows a first example of a luminaire controller of the invention;

FIG. 5 shows a second example of a luminaire controller of the invention;

FIG. 6 shows the luminaire controller of FIG. 5 with the rotary arm fixed in a different configuration to FIG. 5;

FIG. 7 shows a cross section of the luminaire controller;

FIG. 8 shows an outdoor luminaire with a luminaire controller mounted on an upper external face of the luminaire main housing, and shows an overlap problem; and

FIG. 9 shows how the adjustment of the cable routing unit enables the problem of FIG. 8 to be addressed.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an outdoor luminaire controller having a housing and a cable routing unit mounted at a base of the housing, for passing a cable from the housing to the outside of the housing beneath the base, and for connecting the luminaire controller to the external face. The cable routing unit has an adjustable configuration relative to the base so that the location from which the cable extends down from the base can be adjusted. The luminaire controller can be configured to different designs of luminaire, in particular with a cable entrance hole in different positions.

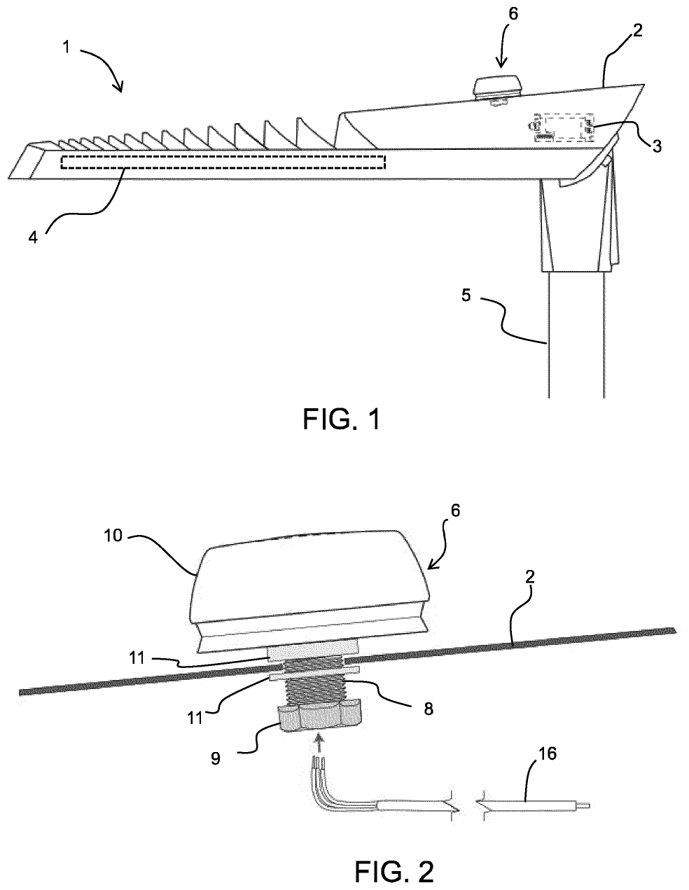

FIG. 1 shows one example of a known street light luminaire 1. The luminaire 1 comprises a main housing 2 which houses a lighting driver 3, a light source 4 (such as an LED arrangement) and other circuitry. The luminaire is mounted on a lighting pole 5. FIG. 1 shows a cooling fin arrangement above the light source.

A luminaire controller 6 is mounted on an external face of the luminaire main housing 2. The luminaire controller 6 enables the luminaire to be connected wirelessly to a main lighting management system using a cellular telephone network.

Optionally, the luminaire controller 6 also provides automated lighting control by incorporating a light sensor and a switching arrangement for controlling the supply of power to the lighting driver 3 in dependence on the ambient lighting conditions.

Other functions may of course be implemented in the luminaire controller. This invention is concerned with the connection between the luminaire controller 6 and the main housing 2 of the luminaire, and may be used with any choice of internal components of the luminaire controller and any choice of internal components of the main housing of the luminaire.

FIG. 2 shows the known connection between the luminaire controller 6 and the main housing 2. The main housing 2 has a hole in an external wall. The luminaire controller 6 has a hollow threaded shaft 8 which fits through the hole, and the housing 10 of the luminaire controller 6 is clamped to the main housing 2 using a nut 9 and the threaded shaft 8, and with a pair of washers 11.

The cable 16 passes through a central bore of the hollow threaded shaft 8. The hollow threaded shaft 8 thus functions as a collar around the cable 16.

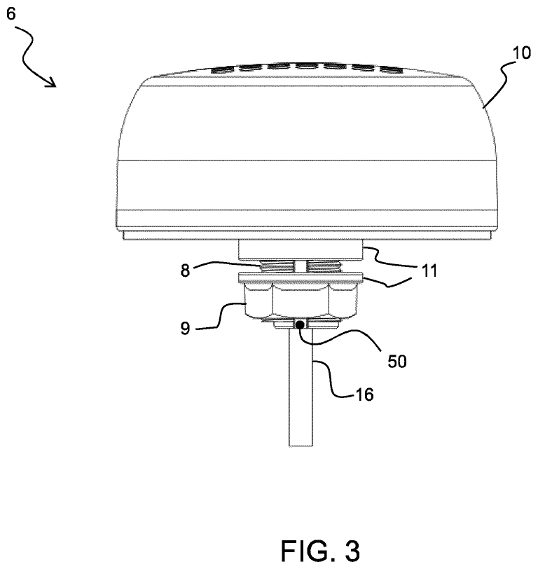

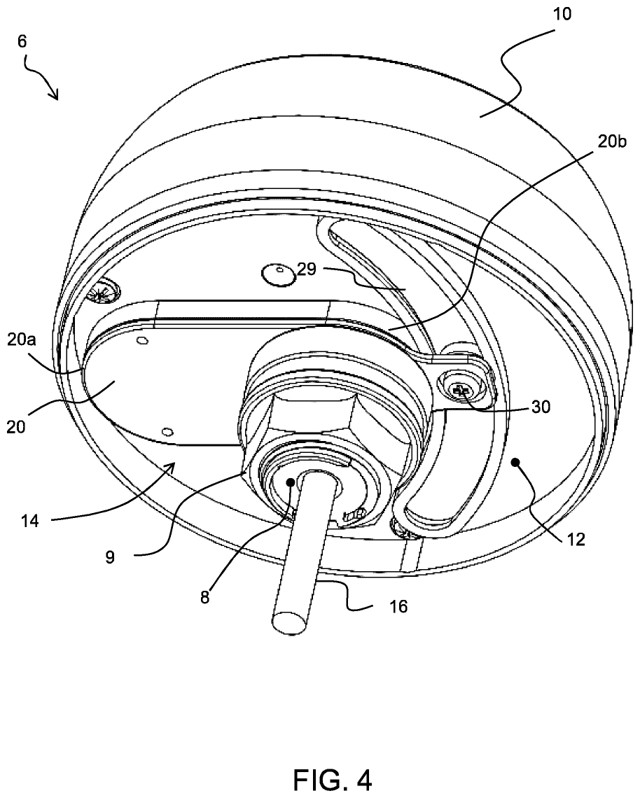

FIG. 3 shows the luminaire controller 6 separate from the luminaire main housing. The threaded shaft 8 has a slot 50, so that it can engage with a tab formed as part of the cable entrance hole of the luminaire housing, thereby to prevent rotation of the lighting controller. This makes the tightening of the nut simpler.

A cable clamping element is for example mounted between the cable 16 and the bore of the threaded shaft.

To the extent described above, the luminaire controller is known.

FIG. 4 shows an example of a luminaire controller 6 of the invention, for mounting on an external face of an outdoor luminaire, as explained above.

The luminaire controller again has housing 10 having an interior volume closed by a base 12. A cable routing unit 14 is mounted at the base 12 for passing a cable 16 from the interior volume of the housing 10 through the base 12 to the outside of the housing beneath the base. The cable routing unit also connects mechanically the luminaire controller 6 to the external face using a nut and threaded shaft connection, as explained above.

The cable routing unit 14 has an adjustable configuration relative to the base 12 of the housing so that the location from which the cable 16 extends down from the base 12 can be adjusted.

FIG. 4 shows the cable extending down from a central position of the base 12. This corresponds to a conventional design, and it means the design of the invention may be used as a direct replacement for existing luminaire controller designs. The ability to change the location from which the cable 16 extends allows more flexibility in the use of the luminaire controller, in particular to enable different positions of the cable entrance hole in the external wall of the luminaire main housing.

The cable routing unit 14 comprises a rotary arm 20 rotatably mounted to the base 12. The rotary arm has a first end 20a at which it is pivotably coupled to the base 12 and a second end 20b at which the collar 8 (i.e., the hollow threaded shaft) is mounted. Thus, the collar is mounted at the free movable end of the arm 20 where the range of movement is greatest. The first end 20a is pivotably coupled near a peripheral location of the base, i.e. near the outer edge of the base. This enables the arm to be as long as possible, and hence with the greatest range of adjustment at its free end.

In the example shown, the housing is circular, the pivot location is near the periphery, and the arm is slightly shorter than the radius of the circle, so that one possible location of the collar is central, as mentioned above and as shown in FIG. 4.

When the rotary arm 20 is rotated (about a pivot axis near the first end 20a) the second end and hence the collar 8 follows the path of an arc in a plane parallel to the base 12 of the housing 10. The arm 20 can rotate so that the free end can be positioned anywhere between the two peripheral locations along the arc. The arc thus has a range of around 120 degrees and a radius approximately equal to the radius of the base 12.

The rotary arm can be locked in position, and hence with the collar and the cable exit location locked in position, at a desired position along the arc. The position of the collar defines the position at which the cable exits the luminaire controller, and then enters the luminaire, as the cable passes through the central bore of the collar.

In the example of FIG. 4, the rotary arm may be locked in any position along the arc. For this purpose, there is an arc shaped slot 29 which guides a fixing arrangement having a fixing screw 30. The fixing screw may be tightened to fix the rotary arm in position.

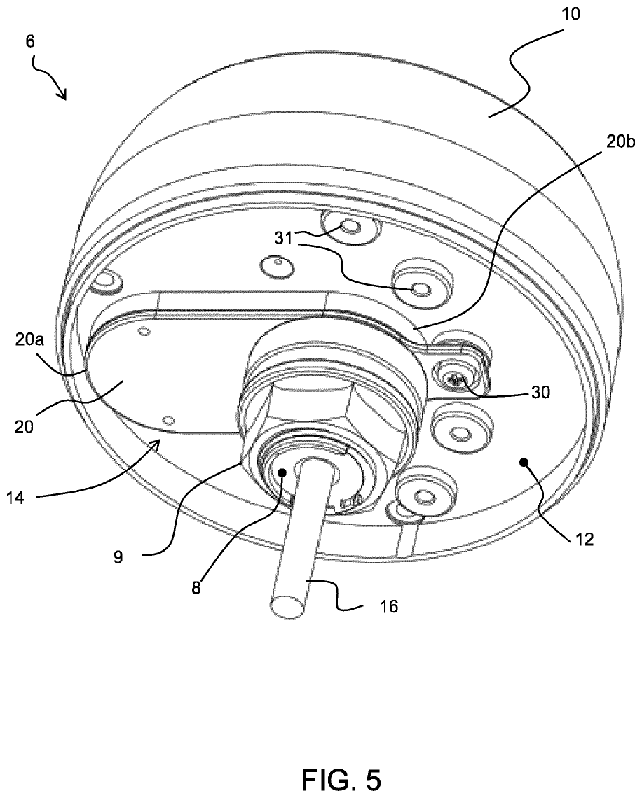

FIG. 5 shows an alternative example in which there is a set of five discrete locking positions. The fixing screw 30 again functions as a locking arrangement for locking the rotary arm 20 in the selected position along the arc. In this example, the fixing screw engages with a selected one of a set of threaded bores 31. This prevents the luminaire controller moving once installed.

In both examples, the rotary arm 20 defines a hollow chamber, and the hollow chamber functions as a cable passageway internally within the rotary arm 20 extending between the first and second ends. The cable passageway couples to the interior volume of the housing 10 at the first end 20a and couples to the collar 8 at the second end. The cable 16 is thus protected in its passage between the base 12 of the luminaire controller and the main housing of the luminaire.

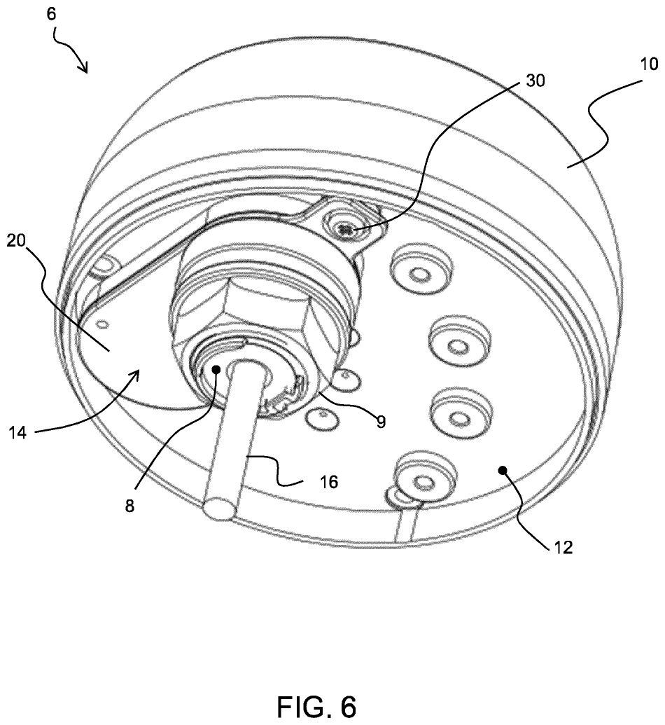

FIG. 6 shows the luminaire controller with the rotary arm 20 fixed in a different configuration to FIG. 5. The cable now exits the luminaire housing at a more peripheral location of the base.

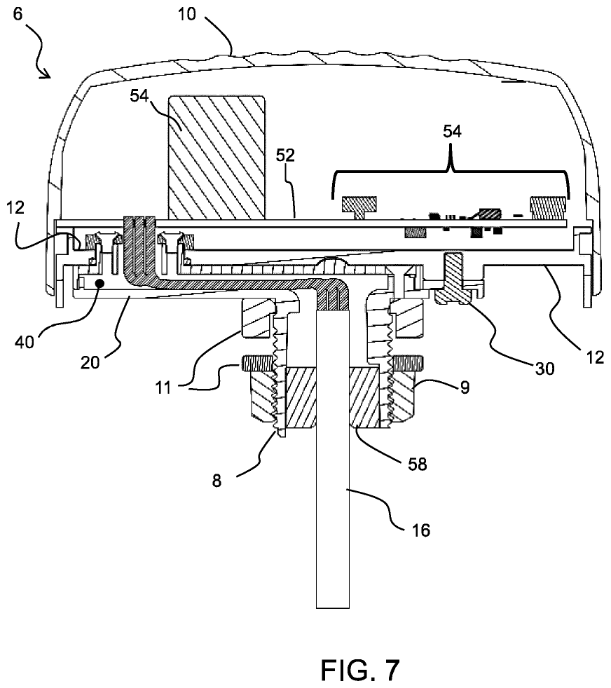

FIG. 7 shows a cross section of the luminaire controller 6. The housing 10 contains a printed circuit board 52 on which electronic circuitry and other components, 54, are mounted, such as a light sensor, a cellular communications system for communicating with a lighting management system and a switching arrangement for controlling the switching of a mains supply to the luminaire.

FIG. 7 shows the cable passageway 40 formed by the rotary arm 20, which couples to the interior volume of the housing 10 and to the internal bore of the collar 8. The cable passes along the axis of rotation of the rotary arm 20 where the cable enters the housing 10. Thus, the rotary coupling between the rotary arm and the housing is annular, around the cable location. A cable clamping element 58, as mentioned above, is also shown between the internal bore of the collar 8 and the cable 16.

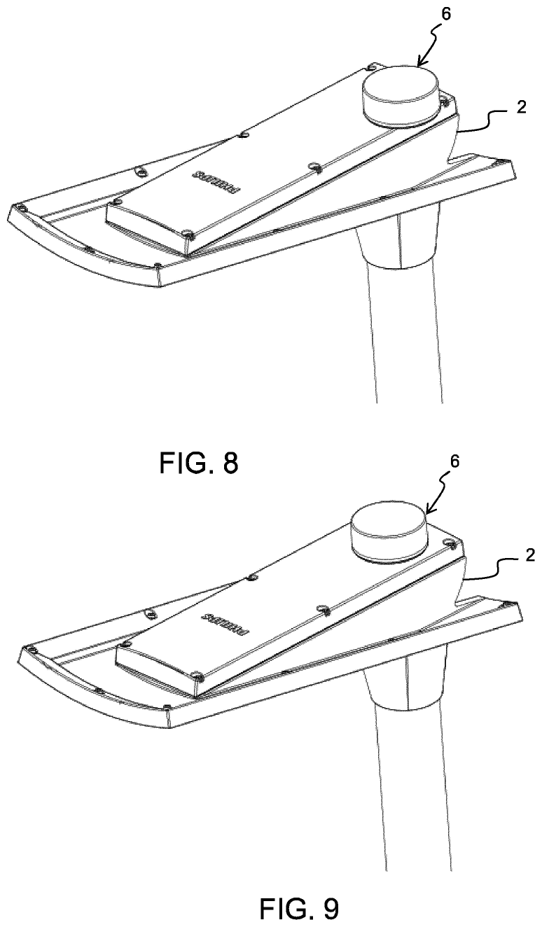

FIG. 8 shows an outdoor luminaire with a luminaire controller 6 mounted on an upper external face of the luminaire main housing 2, and shows the problem that can arise with the conventional luminaire controller of FIGS. 2 and 3, if the cable entrance hole is located at an edge of the luminaire main housing. An overlap can be seen in FIG. 7, and this can lead to water ingress and reduced impact resistance, as well as affecting the visual appearance.

FIG. 9 shows how the adjustment of the cable routing unit enables the problem of FIG. 8 to be addressed, enabling the luminaire controller to be positioned more centrally over the external face of the luminaire main housing, even though the cable entrance hole is near an edge.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. An outdoor luminaire controller for mounting on an external face of an outdoor luminaire, comprising:
a housing having an interior volume closed by a base; and
a cable routing unit mounted at the base for passing a cable from the interior volume of the housing through the base to the outside of the housing beneath the base, and for connecting the luminaire controller to the external face,
wherein the cable routing unit has an adjustable configuration relative to the base of the housing thereby to adjust the location from which the cable extends down from the base.

2. The luminaire controller of claim 1, wherein the cable routing unit comprises:
a rotary army rotatably mounted to the base; and
a collar mounted on the rotary arm and extending downwardly from the rotary arm,
wherein the rotary arm is rotatable to enable the collar to be positioned at a range of positions along an arc beneath the base of the housing.

3. The luminaire controller of claim 2, further comprising a locking arrangement for locking the rotary arm in a selected position along the arc.

4. The luminaire controller of claim 3, wherein the locking arrangement, is for locking the rotary arm:
in a selected position along a continuous range of possible positions along the arc; or
in a selected one of a discrete set of positions along the arc.

5. The luminaire controller of claim 2, wherein the rotary arm has a first endue pivotably coupled to the base and a second end at which the collar is mounted.

6. The luminaire controller of claim 5, wherein the rotary arm comprises a cable passageway internally within the rotary arm extending between the first and second ends, wherein the cable passageway couples to the interior volume at the first end and couples to the collar at the second end.

7. The luminaire controller of claim 5, wherein the first end is pivotably coupled to a peripheral location of the base.

8. The luminaire controller of claim 2, wherein the collar has a rotation prevention slot to prevent rotation of the outdoor luminaire controller when mounted to a luminaire.

9. The luminaire controller of claim 1, wherein the housing is circular, and the cable routing unit has one possible configuration in which the cable extends down from the center of the base.

10. The luminaire controller of claim 1, comprising, in the housing, a cellular communication system for communicating with a lighting management system.

11. The luminaire controller of claim 1, comprising, in the housing, a light sensor, and a switching arrangement for controlling the switching of a mains supply to the luminaire.

12. An outdoor luminaire comprising:
a luminaire main housing;
a light source and a lighting driver mounted in the luminaire main housing; and
the luminaire controller as claimed in claim 1 mounted on an external face of the luminaire main housing.

13. The luminaire of claim 12, wherein the external face has a hole, and the cable routing unit mechanically connects the luminaire controller to the external face at the location of the hole, with a cable passing through the hole between the luminaire main housing and the housing of the luminaire controller.

14. The luminaire of claim 12, wherein the luminaire controller is mounted on an upper external surface of the luminaire housing.

15. The luminaire of claim 12 comprising a street light.
